(19) United States
(12) Patent Application Publication
(10) Pub. No.: US 2002/0127161 A1
(43) Pub. Date: Sep. 12, 2002

(54) Additive for an air conditioning or refrigeration system

(76) Inventor: Pio Antonio Sgarbi, Houston, TX (US)

Correspondence Address: Wendy K. Buskop, Buskop Law Group, PC, Suite 500, 1717 St. James Place, Houston, TX, 77056, US

(21) Appl. No.: 09/736,620

(22) Filed: Dec. 14, 2000

(51) Int. Cl. C09K 5/00; B01J 7/00

(52) U.S. Cl. 422/198; 252/68; 422/109; 422/199; 48/61; 48/76; 48/127.9

(57) ABSTRACT

A method of improving the thermoconductivity of heat exchange for an air conditioning or refrigeration system, comprising introducing a concentrate into the system which comprises introducing a concentrate into the compressor of the system, the concentrate comprising an amine phosphate deactivator, such as a yellow metal deactivator, a chloronated paraffin, a calcium salt of dialkyl aromatic sulfonic acid, polyalpha-olefin, a nonylated phenylamine derivative, an ashless disperant, carboxylic acid esters, fatty acid derivatives, triazole carbamates and a barium or calcium sulfonate, and an additive having the composition, used in the concentrate, and a compressor driven system utilizing the novel additive.

### FIELD OF THE INVENTION

The present invention relates to an additive for an air conditioning or refrigeration system which enhances the energy exchange process.

### BACKGROUND OF THE INVENTION

Since the early 1970's there has been a constant effort to improve the energy efficiency of cooling units which function on the air conditioning and refrigerant principle. As is well known, air conditioning and refrigeration systems function by relying upon the energy absorbed or released as a compressible fluid undergoes either pressure increase in a compressor or pressure decrease across a valve or other orifice. Typically, these systems rely upon phase changes from the gas to liquid state as a result of changes in pressure to effectuate energy transport. Such air conditioning and refrigeration units are utilized for large commercial installations either for refrigeration or freezing of perishable articles and the like as well as for climate control of large commercial buildings as well as individual dwellings. The energy efficiency of these units has been greatly increased through redesigned compressors, motors and other mechanical and design improvements. Improved methods for lubricating compressors have been developed so as to reduce the frictional energy which must be overcome in the compressor while new compressor designs have also been developed in an attempt to increase the energy efficiency of the systems. However, a need still exists for continued energy improvement in the field of air conditioning and refrigeration systems.

### SUMMARY OF THE INVENTION

Accordingly, it is an object of the present invention to provide an additive which is capable of greatly increasing the energy efficiency of air conditioning or refrigeration systems using a polar compound containing a method of improving the refrigerant flow rates for air conditioning and refrigeration systems, a compressible refrigerant comprising the step of introducing a concentrate into the compressor of the system, the concentrate comprising a amine phosphate, Carboxylic acid esters, yellow metal deactivator, a polyalpha-olefin, a nonylated phenylamine derivative, an ashless disperant, metal and seal conditioners, corrosion protectants and a barium or calcium sulfonate

A further object of the present invention is to provide a method for improving the energy efficiency of air conditioning and refrigeration systems using the unique additive.

Various additional components can be added to the invention including but not limited to: metal conditioners, metal stabilizers, antioxidants, corrosion inhibitors, seal conditioners, tracer dyes, broad spectrum biocides, acid scavengers; water displacement additives or combinations thereof.

### DESCRIPTION OF THE PREFERRED EMBODIMENTS

Typical air conditioning and refrigeration systems in use today rely upon a compressible fluid to transfer the energy from one location to another. The most common energy transfer media are the members of the ozone friendly compressible refrigerants as well as ammonia. Ammonia finds particular application in large-scale refrigeration systems such as cold storage units and the like. In addition to these two classes of energy transfer media or compressible fluids, other compressible fluids may be utilized which undergo phase changes under reasonable changes of pressure. Such compressible fluids which undergo the necessary change from liquid to gaseous states by the change in pressure are well known in the art and include gases such as carbon dioxide. In general the selection of the energy transfer media is dependent upon a number of design criteria which are well known. In general, for commercial installations the use of either refrigerant or ammonia is most preferred. However in special applications media such as carbon dioxide may be utilized.

The polar organic compound of the present invention contains sufficient polar groups so as to provide regions of the molecule which have high electron densities and other regions which have low electron densities. The particular compound selected must obviously be compatible with the compressible fluid being utilized as the energy transfer media and with the materials of construction of the various components of the energy transfer system. Furthermore, the compounds must remain essentially liquid under the operating conditions encountered. That is, there must be only inconsequential solidification in the cold portion or expansion section of the air conditioning and refrigeration system and only minimal volatilization when exposed to the high temperatures on the high pressure side of the system that is, the polar compound is essentially non-compressible under operating conditions. In addition to being compatible with both the energy transfer medium and the materials of construction of the air conditioning and refrigeration system, polar compound must also be selected to be compatible with the lubricants typically encountered in air conditioning and refrigeration systems. As is well known, all air conditioning and refrigeration systems contain a lubricant which is continuously circulating throughout the system to lubricate the moving parts of the compressor. Typically these lubricants are based upon naphthenic oils. The most common of the lubricants are designated 3GS and 4GS refrigeration oils.

The present invention relates the use of a thermoconductive lubricant for heat pumps, refrigeration and air conditioning. In a preferred embodiment, the additive uses a synthetic hydrocarbon lubricant formulated with carboxylicic aliphatic ester, calcium salts of dialkyl aromatic acids, nonylated phenylamine derivatives, calcium sulfonates, amine sulfonates, chlorinated paraffins and polyalphaolefins. Additional components can be blended with the additive which provide lubricity, stability and resistance to corrosion. As part of an environmental awareness, the present invention relates to lubricants specifically designed to lubricate refrigeration compressors and system components which are ozone friendly, and chlorine free. When the novel compound is used in a refrigeration system, the lubricant exhibits the desired miscibility at critical temperatures, a low viscosity loss, as well as stability for long system life in the air conditioning system.

The polarity of the molecule is believed to result in the polar compound physically attaching itself to the space lattice of the metal walls of the air conditioning and refrigeration system. The metal surfaces in the air conditioning and refrigeration system are believed to contain a high electron charge such that the present polar molecule will orientate itself towards and form a Van Der Waals force and bond with the metal surface. Without being bound by any particular theory, it is believed that when the polar compound binds to the metal wall that this results in a reduction in the boundary layer phenomenon which is encountered in the transfer of energy from a fluid contained within a tube through the tube wall to the surrounding fluid. This boundary layer phenomenon reduces the energy transfer coefficient thereby decreasing efficiency. From tests conducted to date, it appears that the utilization of the polar compound significantly reduces the effect of this boundary layer phenomenon. Tests thus far have demonstrated not only lower energy consumption but also substantially increased energy transfer across the energy transfer surfaces. This improved energy transfer is demonstrated by an increase in the energy transfer coefficient for the system and by shorter system cycle times. As a result of the improved energy transfer, one achieves significantly reduced power consumption in the air conditioning and refrigeration system. Further energy savings can be achieved by taking advantage of the increased energy transfer by reducing the overall size of the air conditioning and refrigeration system for any given load thereby resulting in further energy efficiencies from the use of smaller compressors and the like.

The amount of polar compound which must be added to the air conditioning and refrigeration system is simply that sufficient to achieve the desired increase in energy efficiency. Generally speaking the improved energy efficiency is not achieved immediately upon addition of the polar compound to the system but requires a time delay until the polar compound has become dispersed throughout the system. The length of this delay is to an extent determined by the amount of polar compound added to the system. Accordingly, the amount of polar compound added is determined by the size of the system as well as the rate at which one desires the compound to disperse throughout the system. Typically, the amount of polar compound used is determined by the volume of lubricating oil used in the system. The percentage of polar compound will typically range from about 0.1 to about 10, preferably from 0.5 volume percent up to about 5 volume percent of the lubricating oil. More preferably, the quantity of polar compound will range from about 1% to about 20% of the total lubricant volume. It is preferred that the polar compound be soluble in the lubricant used in the system at the volume percentage of polar compound being utilized. That is, that the solubility of the polar compound exceeds its concentration in the lubricating oil.

This particular composition integrates several types of polar compounds, such as heat seeking and metal seeking molecules. The heat seeking molecules will generally migrate where heat is prevalent such as at the compressor and condensing area of the a/c or refrigeration unit. The metal seeking molecules will then cover the surface on ferrous and non-ferrous metal surfaces. The heat seeking molecules are believed to absorb the heat and dissipate through out the system and the refrigerant cycle. The metal seeking molecules are believed to attach themselves into the space lattice of the metal itself. These molecules act as molecular fins. The molecular fins accelarate the energy transfer once the refrigerant is in circulation, through electromagnetic heat propagation. The heat seeking molecules and the metal seeking molecules work synergistically and create an accelerated method of heat absorbing and dissipation phenomena. Additionally there is a considerable reduction in laminar friction. Once the unit is treated with the invention, the surface of the metal now is stable and free of stagnant oil buildup, the refrigerant now can flow through the tubes with much less resistance thus reducing the amount of pressure and increasing the coefficient of heat transfer of the refrigerant.

In one embodiment, the polar formulation can be manufactured in a pre-packaged unit where the desired refrigerant oil is “pre mixed” with the novel additive. In turn this newly formulated “activated” formulation can totally replace the existing refrigerant oil. This method accelerates the polarization phenomena because the polar compounds are already “mixed” into the oil and less time is needed to totally blend rather than the normal time delay normally found in an additive situation.

As an additional benefit, the formulation can be “Design Specific” where an oil sample from a unit is sent to a lab. From the results, the formulation can take place by adding more or less of the “vital” components. As an example, if the oil sample test results in too much moisture, acidity and metal shavings, then the formulation besides the polar composition will contain an elevated amount of acid scavengers, EP additives, corrosion inhibitors and moisture displacers. This flexibility in formulating “Design Specific” compounds without altering the chemical composition is the embodiment of the novel invention.

In addition to the other physical and chemical properties discussed previously, the polar compound should also be compatible with the lubricating oils.

The polar compound may be introduced into the air conditioning and refrigeration system in any suitable fashion. It may be incorporated into the lubricating oil during the assembly of the system or may be added to the system during operation. If the polar compound is to be added to the system during operation it would be typically injected into the suction side of the compressor. In a particularly preferred embodiment, the polar compound is first dissolved in a carrier compound so as to form a concentrate for easy injection and for better control of the total volume to be added. Generally speaking, the carrier component may be any component which is compatible with the air conditioning and refrigeration system under question. Typically, the carrier will comprise the lubricant being utilized to lubricate the system. Still more preferably the carrier is a white oil, a naphthenic mineral oil of high purity. Such white oils are commercially available and include materials such as Texaco Capella WF and its equivalents. The utilization of white oil has the advantage of being compatible with essentially any air conditioning and refrigeration system including both refrigeration and air conditioning. The refrigeration system is the most demanding because of the low temperatures encountered. The carrier compound must remain liquid throughout the entire air conditioning and refrigeration cycle and should not contain substantial quantities of wax which would solidify under operating conditions. The utilization of white oil as a carrier has the advantage of allowing a single composition containing the polar compound to be utilized in essentially any air conditioning and refrigeration system. The concentration of the polar compound in the carrier is not critical and can range from 20 to 80 volume percent and typically is approximately an equivolume mixture.

The carrier system containing an equal volume mixture of polar compound and carrier may be added to an existing oil system at a 2-15% rate based on the total quantity of lubricant contained in the system. The rate at which the material is added can be greater or lesser depending upon the concentration of polar compound in the carrier material and the desired final concentration of polar compound in the air conditioning and refrigeration system.

When using halogen containing polar compounds it is preferred to use a stabilizer to prevent free halogen from forming if there is any moisture in the system. The presence of free halide can cause corrosion problems. Suitable stabilizers for this concentrate are commercially available and are typically buffers. Such barium sulfonate Tm 906 available from King Industries. Other commercially available compounds containing halogen inhibitors can be utilized as well. The quantity of stabilizer used is not critical and can range from 0.01 to 20 volume percent based on polar compound, more preferably from 0.01 to 10 volume percent. The particular stabilizer selected is not critical so long as it buffers and is compatible with the polar compound, the lubricant and remains dissolved under operating conditions.

It has been determined from testing conducted to date that the present composition and method is effective in improving the efficiency of air conditioning and refrigeration systems both using reciprocating and rotary compressors. Substantial improvements in energy efficiency have been found in all sizes of units ranging from a 1-ton unit up to units nominally rated at 800 tons. Energy consumption improvements of greater than 10% have been achieved by the use of this invention.

The preferred invention involves an ashless dispersant, a calcium salt of dialkyl aromatic sulfonic acid, a nonylated phenylamine, barium sulfonate, amine phosphate yellow metal deactivator, a chlorinated paraffin, and a polyalpha-olefin.

In the preferred embodiment the amine phosphate yellow metal deactivator is from King Industries can be used as a buffer. A calcium sulfonate is the preferred buffer.

The chloronated paraffins is preferably Clorowax AO 500 or Clorowax 57-60 available from Oxy Chem of Dallas, Tex. A barium sulfonate, preferably from King Industries, acts as a buffer, but calcium solufonate is the preferred buffer. The polyalphaolefin (PAO) is SHF-41 available from Exxon-Mobile of Houston, Tex.

### EXAMPLE

Refrigerant flow-rate, capacity enhancement and lubricity improvement technology for all air conditioning and refrigeration systems.

An additive comprising:

20 to 70% Carboxylic aliphatic ester such as Doverlube B-902 from Dover Chemicals, of Dover, Ohio.

2.5 to 10% Calcium Salt of dialkyl aromatic acid such as NA-SUL 729 NF available from King Industries of Norwalk, Conn.

2-15% Nonylated Phenylamine derivative such as NA-LUBE AO-130 from King Industries of Norwalk, Conn.

1 to 5% Calcium Sulfonate such as Lubrizol 78 from Lubrizol of Houston, Tex.

5 to 10% Amine Sulfonate such as LS-3208 from Dover Chemicals of Dover, Ohio.

10 to 30% Chlorinated paraffins and alpha olefins such as Chlorowax available from Oxy Chem of Dallas, Tex.

5 to 40% Polyalpha-olefins such as Exxon SHF 41 from Houston, Tex.

Additionally, the following components can be added to the novel formulation for enhanced useable. These components include separately or in combination,:

2 to 10% Ashless Dithiocarbamate such as NA-LUBE ADTC from King Industries of Norwalk, Conn.;

2 to 15% Hydroxyhydrocinnamic acid alkyl ester such as NA-LUBE AO 240 for King Industries;

2 to 8% Triazole carbamate available from Ciba Geigy of Tarrytown , N.Y.;

1 to 5% 2-6 di-tertiary-butyl-phenol available from Exxon of Houston, Tex.;

Additionally the novel additive may comprise an ashless dispersant such as (HI-TEC 644) available from Ethyl Corporation of Richmond, Va., anti-wear rust and corrosion inhibitors such as (NA-SUL 729 NF); anti-oxidants such as (NA-LUBE AO-130) can be used with amine phosphate yellow metal deactivators such as (NA-LUBE AW-6210) from King Industries. Different grades of chlorinated paraffins can be used, CHLOROWAX AO-500 is the most preferred ingredient, but or Chlorowax 57-60 available from Oxy Cham buffered with barium sulfonate or calcium sulfonate can also be used. The polyalpha-olefin (PAO) carrier (SHF-41) is used to increase the lubricity of the oil, clean the interior parts of the condenser and evaporator, and to convert the insulative layer of non-conductive oil with highly conductive and active polar molecules. This action increases the heat transfer rate of the metal/refrigerant ratio through “electromagnetic heat propagation.” The combination and chemical concentration is designed to vary for different applications from ammonia units, centrifugals, reciprocal and cross systems

Finally, an antiwear amine salt can be added to the additive, such as from 1-10 wt % of an antiwear alkyl phosphate amine salt. NA-Lube 6210 can additionally act as the antiwear alkylphosphate amine salt in addition to acting as the amine phosphate deactivator. NA Lube 6210 is particularly useful with yellow metals, such as copper, bronze, brass, similar non-ferrous metals.

By using the characteristics of the ashless dispersants, this chemical composition is able to remove the sludge and oil build-up in the coils (a major problem with any air conditioning, refrigeration and heat pump units), the oil that is removed returns to the compressor where it belongs. The active polar molecules now are able to attach themselves to the space lattice of the metal parts of the compressor, evaporator, and condenser. This action accelerates heat transfer. The yellow metal deactivators will protect the internal parts from corrosion, rust and acid deterioration. The inhibitors will prevent acid build-up also in the case where the motor windings are slightly stripped and shorting-out. Once the metal surface is “activated” the refrigerant can now flow through the pipes without laminar friction. By accelerating the flow-rate of the refrigerant, more refrigerant can now flow through the pipes giving the system considerable increase in capacity. The combination of the chlorinated paraffin along with the barium sulfonate will increase the lubricity of the oil due to their extreme pressure characteristics and polar composition. The result of the use of the novel concentrate is the considerable increase in performance through strategic combination of: heat transfer, dramatic increase in lubricity, accelerated refrigerant flow rate, reduced thermo-cycling of the compressor oil, and extended equipment life.

The following test was performed:

MAIN CHILLER (350 TON CENTRIFUGAL)

| | | AFTER | |
|---|---|---|---|
| | BASELINE | TREATMENT | |
| | (08/10 TO | (08/24 TO | |
| | 08/17) | 08/31) | VARIANCE |
| Chilled H2O Supply | 45° F. | 43° F. | −2° F. |
| Temp. | | | |
| Chilled H2O Return | 54° F. | 50° F. | −4° F. |
| Temp. | | | |
| Condenser Supply Temp. | 88° F. | 82° F. | −6° F. |
| Condenser Return Temp. | 94° F. | 90° F. | −4° F. |
| kW Demand | 280 kW | 190 kW | −90 kW |
| KW/Ton (PLV) | .80 kW/ton | .54 kW/ton | −.26 kW/ton |
| Run Hours | 168 hrs. | 168 hrs. | −0− hrs. |
| Temp. (Motor Casing) | 69° F. | 64° F. | −5° F. |
| TOTAL kWh | 47,040 kWh | 31,920 kWh | −15,120 kWh |
| CONSUMPTION | | | |

I. Metal Conditioners

Metal conditioners can be added to the formulation. A preferred metal conditioner would be a 3,5-di-tert-butyl-4-hydroxyhydrocinnamic acid, blended with a 7-9 Carbon branched alklyl ester, and a trietary carbon atom united to 3 other carbon atoms, and a nonlyated phenylamine derivative, with a calcium salt of dialklyl aromatic sulfonic acid, and aromatic hydrocarbons of special types with unique unsaturation C₈H₅ O₇SNa.

II. Metal Stabilizers and Yellow Metal Deactivators

Metal stabilizers comprising a calcium salt of a dialkyl aromatic sulfonic acid, and methylene-bis-(dibutyldithicarbamate) can be used with the polar compound.

III. Antioxidants and Corrosion Inhibitors

Antioxidants and corrosion inhibitors with a yellow metal deactivator comprising a calcium salt of dialkyl aromatic sulfonic acid, a 3,5-di-tert-butyl-4-hydroxyhydrocinnamic acid, C₇₋₉ branched alklyl ester nonylated phenylamine derivative, a calcium salt of dialkyl aromatic sulfonic acid can be used to enhance the novel composition.

IV. Seal Conditioner

Seal conditioners can be used in the invention to enhance and provide longevity for seals in the air conditioning system. A preferred seal conditioner is an esterified heptanol acid created di-ester, such as C₇H₁₆O₂.

V. Tracer Dyes

It is contemplated that tracer dyes can be used within the scope of this invention. A fluorescent dye is considered the best mode when used with the novel composition.

VI. Broad Spectrum Biocides

Biocides stop the growth of fungus and biologicals, such as bacteria in the air conditioning systems. A preferred biocide is a 3-iodopropynylbutylcarbamate. It is contemplated that in the most preferred embodiment, two carbonates can be used simultaneously in the invention.

VII. Acid Scavengers

Acid scavengers can be added to the novel composition to prevent corrosion by controlling the free acids created because of the metal tubing used in the air conditioning system calcium salt of dialkyl aromatic sulfonic acid.

VIII. Water Displacement Additive

This additive is added because the polar compound creates a van der waal force effect in conjunction with the air conditioning tubing. The additive pulls the water away from the wall, and helps prevent forming of sludge on the sides of the tubing, and prevents blockages in the tubing. The preferred water displacement additive is a calcium salt of dialkyl aromatic sulfonic acid.

The advantages of the present invention are to create a lubricant with a long life, controlled miscibility, a high efficiency system, excellent temperature fluidity, and excellent high temperature stability.

Obviously, numerous modifications and variations of the present invention are possible in light of the above teachings. It is therefore to be understood that within the scope of the appended claims, the invention may be practiced otherwise than as specifically described herein.

The oil migration into coils and evaporator units in an a/c and/or refrigeration system was found to be detrimental in heat transference. Oil absorbs energy. The layer of oil on the metal surface acts as an insulative blanket or layer that reduces the designed metal's (copper/aluminum) ability to transfer heat.

This technology replaces the insulative stratum of non-conductive material from the surface of the metal and replaces it with highly conductive polar molecules.

Another beneficial derivative from this technology is the added lubricity and heat transfer of the compressor parts. This acts as two prong benefits: 1) reduction of the heat caused by friction (hence less expansion of the metal parts), less pressures and less wear and tear; and, 2) by embedding polar molecules into the space lattice of the metal surface, reduced wear and tear are expected from cold starts and unexpected lubricant “washout” caused by the refrigerant assimilation with the oil from the compressors moving parts. Treated molecules will stay on the metal and protect it from cold starts. Further benefits are associated through: oxidation inhibitors, seal protectants, metal conditioners, acid scavengers (to reduce acid buildup). Viscosity index improvers, extreme pressure additives, broad spectrum biocides, defoamers and tracer elements.

The following benefits are seen from the unique formulations:

Reduced run time

Reduced wear

Reduced temperatures

Increased lubrication

Increased refrigerant flow rates

Increased heat transfer

Extended equipment life

Longer oil life

Protection against internal corrosion

Increased protection to compressor seals

Quieter operation

Reduced energy draw

Reduced start-up demand

Increased volumetric efficiency

What is claimed is:

1. A method of improving the thermoconductive heat exchange for air conditioning and refrigeration systems: a compressible refrigerant comprising the step of introducing a concentrate into the compressor of the system, the concentrate comprising an amine phosphate deactivator, a chlorinated paraffin, a calcium salt of dialkyl aromatic acid, polyalpha-olefin, a nonylated phenylamine derivative, an ashless disperant, a calcium sulfonate, and a carboxylic aliphatic ester.

2. The method of claim 1, wherein said polar compound is present in an amount from 1 to 40 percent by volume of the total volume of lubricant in the compressor.

3. The method of claim 1, wherein said step of introducing to said concentrate the additional ingredients of:

| | |
|---|---|
| 10 to 60% | Carboxilic acid esters. |
| 5 to 30% | fatty acid derivatives |
| 2.5 to 10% | calcium salt of dialkyl aromatic acid; |
| 2-15% | nonylated phenylamine derivative; |
| 1 to 5% | calcium sulfonate; |
| 5 to 10% | amine phosphate deactivator; |
| 10 to 30% | chlorinated paraffins; and |
| 5 to 40% | polyalpha-olefins. |

4. In a compressor driven system for removing heat using a thermoconductive compressible liquid refrigerant, the improvement comprises an amine phosphate yellow metal deactivator, a carboxylic acid ester, a (chloronated paraffin), a calcium salt of dialkyl aromatic sulfonic acid, polyalpha-olefin, a nonylated phenylamine derivative, fatty acids, an ashless dispersant, and a calcium sulfonate.

5. In a compressor driven system for removing heat using a thermoconductive compressible liquid refrigerant, the improvement comprises an amine phosphate yellow metal deactivator, a chlorinated paraffin, a calcium salt of dialkyl aromatic sulfonic acid, a polyalpha-olefin, a nonylated phenylamine derivative, an ashless dispersant and a barium sulfonate.

6. An additive for improving the thermoconductivity or heat transfer of air conditioning and refrigerant systems comprising: an amine phosphate yellow metal deactivator, a chloronated paraffin, a calcium salt of dialkyl aromatic sulfonic acid, polyalpha-olefin, a nonylated phenylamine derivative, an ashless disperant, and a barium sulfonate.

7. The additive of claim 5, wherein said additive comprises:

| | |
|---|---|
| 20 to 70% | carboxilic aliphatic ester; |
| 2.5 to 10% | calcium salt of dialkyl aromatic acid; |
| 2-15% | nonylated phenylamine derivative; |
| 10-30% | Fatty acid derivatives |
| 1 to 5% | calcium sulfonate; |
| 5 to 10% | amine phosphate deactivator; |
| 10 to 30% | chlorinated paraffins; and |
| 5 to 40% | polyalpha-olefins. |

8. The additive of claim 5, wherein extreme pressure additives are further mixed with the additive.

9. The additive of claim 5, wherein naphthenic oil is used as a carrier.

10. The additive of claim 5, further comprising an additional member of the group consisting of:
a metal conditioner, a metal stabilizer, a corrosion inhibitor, an antioxidant, a seal conditioner, a tracer dye, a biocide, an acid scavenger, a water displacement additive, and combinations thereof.

11. The additive of claim 5, further comprising alkanolamine.

12. The additive of claim 5, further comprising 2-8% triazole carbonates.

13. The additive of claim 5, further comprising 2-10% ashless dithiocarbamate.

14. The additive of claim 5, further comprising 2-15% hyroxyhdrocinnamic acid alkyl ester.

15. The additive of claim 5, further comprising 1-5% of 2-6 ditertiary-butyl-phenol.

16. The additive of claim 5, further comprising 1 - 10 wt % antiwear alkylphosphate amine salt.
